(19) United States
(12) Patent Application Publication
(10) Pub. No.: US 2018/0038130 A1
(43) Pub. Date: Feb. 8, 2018

(54) Door Hardware and Method of Installation

(71) Applicant: Roderick Nigel Redgrave, Auckland (NZ)

(72) Inventor: Roderick Nigel Redgrave, Auckland (NZ)

(73) Assignee: Roderick Nigel Redgrave, Auckland (NZ)

(21) Appl. No.: 15/789,551

(22) Filed: Oct. 20, 2017

Related U.S. Application Data
(63) Continuation of application No. 14/800,957, filed on Jul. 16, 2015, now abandoned.

(30) Foreign Application Priority Data
Jul. 17, 2014 (NZ) 627522

(51) Int. Cl. E05B 9/08; E05B 17/06

(52) U.S. Cl. CPC E05B 9/08; E05B 17/06; E05B 9/002

(57) ABSTRACT

This invention relates to an improved aesthetically appearing and easy to install door hardware, including a flanged housing for door-hardware mounting plates having a built-in drilling/screw positioning plate.

### CROSS-REFERENCE TO RELATED APPLICATIONS

This US continuation application claims priority to U.S. patent application Ser. No. 14/800,957 filed Jul. 16, 2015 which claims priority to New Zealand Patent Application No. 627522 filed 17 Jul. 2014, each of which is incorporated herein by reference.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable

### REFERENCE TO A SEQUENCE LISTING

Not Applicable

### BACKGROUND OF THE INVENTION

The invention relates to improved door hardware and the installation thereof. More particularly, the invention relates to door hardware with an improved aesthetic appearance while being easier and quicker to install. More particularly, the invention relates to a flanged housing for door hardware mounting plates that incorporates a built in drilling/screw positioning guide, and the installation method thereof.

Swing doors are often hinged along a vertical edge to a door jamb, and have a latch assembly installed in the edge of the door opposite the hinges which engages with a strike plate installed in the door frame.

A latch bolt is a part of the latch assembly mounted in a hole bored into the door and having a head which fits into a shallow rebate in the surface of the door edge. The latch bolt is able to move in and out of a hole in the head of the latch assembly. Often the latch bolt is spring loaded to urge it to protrude outwards from the edge of the door. The assembly often includes a mechanism that allows someone to retract the latch bolt back into the edge of the door, for example by turning a door handle. Often the end of the latch bolt has an angled or contoured profile on the side that the door closes towards, to allow it to be smoothly pushed back into the door when engaging with the strike plate.

The strike plate fits into a rebate in the door jamb in a position adjacent the latch bolt when the door is closed. The strike plate often has a hole, which when installed is positioned over a hole in the jamb that receives the latch bolt when the door is closed. The strike plate often has a curved lip protruding from its side towards the opening side of the door,—the lip providing a contoured contact surface to smoothly push the latch bolt backwards into the door, allowing the door to shut. The latch bolt can then protrude from the door edge into the hole in the strike plate, preventing the door from opening again, unless the latch bolt is pulled backwards, for example by someone turning a door handle connected to the latch assembly.

Another bolt, independent of the latch bolt is sometimes installed in a door in order to provide a locking mechanism independent of the latch and door handle assembly, for example a dead bolt. A dead bolt is often part of an assembly having a faceplate mounted within the door, and also having a corresponding strike plate, which may be the same strike plate as is associated with the latch bolt, although in such a case the strike plate will have two holes, one for the latch bolt and one for the dead bolt. A dead bolt may not spring loaded and may need to be deliberately moved between the extended position in which it is used to lock the door, and a retracted position in which it is within the door. For this reason the strike plate corresponding to a dead bolt may not have a contoured lip.

Sliding doors often also have latch bolt type assemblies with heads and corresponding strike plates that fit into recesses in the door. Bolts on sliding doors may have a hooked end to prevent the sliding door being opened unless the bolt is disengaged.

When the door and/or jamb are wooden, it can be time consuming and difficult to install this conventional and widely used hardware because of the need to cut the rebates in the door and door jamb to house the latch head and the strike, respectively.

In particular, where a builder needs to cut the recesses in a door and jamb on the building site, they often only have basic hand tools, and therefore crudely chisel out the recess, which can be a time consuming process and can leave an untidy appearance around the edges of the strike plate.

Latch assemblies and strikes are currently available with heads and strike plates that have curved ends rather than being a rectangular shape. However, to prepare the rebates in the door edge and jamb for a plate with curved ends, more complicated tools are typically required, such as a router and template jig. Such tools are expensive, difficult to transport and use on site and therefore may often not be carried by door installers.

It would be advantageous if door hardware existed that was quicker and easier to install while leaving a tidier finish.

It would also be advantageous if hardware and/or methods existed that enabled quick preparation of a door edge or jamb for use with a latch faceplate and/or strike plate with curved edges, while only requiring basic tools.

### BRIEF SUMMARY OF THE INVENTION

It is an object of the invention to provide improved door hardware.

Alternatively, it is an object of the invention to address at least one of the foregoing problems or at least provide the public with a useful choice.

According to a first embodiment of the invention there is provided a template member for use in mounting a strike or latch assembly to a door or door jamb, the template member comprising:
a body comprising a central portion adapted to fit within a latch hole in a door edge or door jamb, and a planar portion extending from the central portion, the planar portion being configured to be positioned against the surface of the door edge/jamb surrounding the latch hole when the central portion is fitted in the latch hole;
wherein the planar portion comprises at least one outwardly projecting portion on at least one side of the central portion, such that the planar portion comprises two semi-circular sides connected by two straight sides;
wherein each outwardly projecting portion comprises a guide hole substantially concentric with the centre of the respective semi-circular side.

Preferably, the planar portion projects outwardly from an end of the central portion perpendicularly away from the central portion.

Preferably, the planar portion comprises two outwardly projecting portions on opposing sides of the central portion.

Preferably, the planar portion comprises a length and a width, the length being between two and three times larger than the width.

Preferably, the central portion comprises a central hole through at least a portion thereof, the central hole having an opening at the end of the central portion from which the planar portion projects, the central hole configured to receive a latch bolt therein. More preferably, the central hole is closed on the other side of the central portion.

Preferably, the template member comprises a magnet positioned in the central hole, the magnet configured to attract a latch bolt in use.

Preferably, the template member comprises a protective covering over the magnet.

Preferably, the template member is formed from a plastics material.

According to a second embodiment of the invention there is provided a method of creating a recess in a door or a jamb, comprising:
a) drilling a first hole into the door or the jamb, as the case may be;
b) drilling a second hole having a centre offset from the centre of the first hole;
c) widening the second hole to substantially the same diameter as the first hole, to at least a portion of the depth of the first hole;
d) removing material from the door or jamb, as the case may be, to form a recess comprising two substantially straight sides, each straight side substantially tangent to each of the previously drilled holes.

Preferably the method comprises, before step d),
drilling a third hole proximate one of the previously drilled holes, the third hole substantially positioned on the line intersecting the centres of both the first and second holes; and
widening the third hole to substantially the same diameter as the first hole, to at least a portion of the depth of the first hole.

When the method comprises the preferable step of drilling the third hole proximate one of the previously drilled holes, step d) of the method would therefore involve removing material to form a recess comprising two substantially straight sides each substantially tangent to each of the three previously drilled holes.

Preferably, the method comprises, after step a), inserting the central portion of a template member according to the first embodiment of the invention into the first hole, and drilling the second hole and the third hole each at the location of a guide hole of the template member.

Preferably, the method comprises marking the position of the second and/or third holes through first and/or second guide holes in the template member prior to drilling the second and/or third holes.

In some embodiments, the recess is configured to receive a latch assembly.

In some embodiments, the recess is configured to receive a strike assembly.

According to a third embodiment of the invention there is provided a receiving member for a latch assembly or strike assembly, the receiving member comprising:
a plate member having a hole therein, the hole being configured to allow a latch to pass therethrough;
a wall around the perimeter of the plate member, the wall extending away from and substantially perpendicular to the plate member; and
a flange extending outwardly from the perimeter of the wall distal from the plate member,
wherein the receiving member is configured to be mounted in a recess in a door jamb or door edge such that the flange abuts a surface of the door jamb or door edge, as the case may be, and substantially conceals the edge of the recess.

Preferably, the plate member comprises a shape having a length and a width, the length being greater than the width. More preferably, the length is between two and three times greater than the width.

Preferably, the hole configured to allow a latch to pass therethrough is located substantially in the middle of the length of the plate member.

Preferably, the hole is circular and has a diameter substantially equal to the width of the plate member.

Preferably, the plate member comprises two semi-circular sides connected by two straight sides.

Preferably, the plate member comprises two fastener holes each substantially concentric with the centre of one of the semi-circular sides.

Preferably, the plate member is formed from sheet metal.

Preferably, the receiving member is configured to receive one or more further components of a latch assembly or a strike assembly, within the space between the wall and the plate member.

Preferably, the receiving member is configured to receive a template member according to the first embodiment of the invention.

Preferably, the receiving member is configured to fit into a recess formed by a method according to the second embodiment of the invention.

According to a fourth embodiment of the invention there is provided a strike assembly for a door jamb, comprising a receiving member as described in the third embodiment of the invention.

Preferably, the strike assembly comprises a template member according to the first embodiment of the invention, the template member being received by the receiving member.

Preferably, the strike assembly comprises a plate of substantially the same shape and size as the planar portion of the template member.

Preferably, the plate comprises a central hole configured to receive a latch bolt, the hole in the plate being positioned over the hole in the central portion of the template member when the strike assembly is assembled.

Preferably, the plate comprises two tabs each extending perpendicular to the plane of the plate and configured to be received in the central hole in the central portion of the template member when the strike assembly is assembled. More preferably the tabs are located on opposite sides of the central hole and are both located substantially at the middle of the length of the plate.

Preferably, the plate comprises two fastener holes aligned with the guide holes of the template member and the fastener holes of the receiving member.

Preferably, the plate is formed from sheet metal.

Preferably, the strike assembly comprises a cover having a shape and size substantially corresponding to the plate member and having a central hole corresponding to the central hole in the plate member, the cover adhered to the plate member when the strike assembly is assembled.

Preferably, the strike assembly is configured to fit within a recess formed by the method according to the second aspect of the invention.

According to a fifth aspect of the invention there is provided a latch assembly for a door edge, comprising a receiving member as described in the first embodiment of the invention.

Preferably, the latch assembly comprises a latch having a latch head configured to be received by the receiving member. More preferably, the head of the latch is of substantially a corresponding shape size to the space between the wall and plate member of the receiving member.

Preferably, the latch head comprises two fastener holes aligned with the fastener holes of the receiving member.

Preferably, the latch assembly further comprises a cover having a shape and size corresponding to the latch head and having a central hole configured to allow a latch bolt to extend from the latch head therethrough, the cover being adhered to the latch head when the latch assembly is assembled.

Preferably, the latch bolt is magnetic, and is biased towards a retracted position.

Preferably, the latch assembly is configured to fit within a recess formed by a method according to the second embodiment of the invention.

According to a sixth embodiment of the invention there is provided a kit for a door closure system, comprising one or both of:
a strike assembly according to the fourth embodiment of the invention; and
a latch assembly according to the fifth embodiment of the invention.

Preferably, the kit further comprises a template member according to the first embodiment of the invention.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is a perspective view illustration of a receiving member according to an embodiment of the invention;

FIG. 2 is a perspective view illustration of a latch assembly according to an embodiment of the invention;

FIG. 3 is a perspective view illustration of a template member according to an embodiment of the invention;

FIG. 4 is a front view illustration of one of the steps required in a method according to an embodiment of the invention;

FIG. 5 is a front view illustration of another of the steps required in the method according to the embodiment of the invention shown in FIG. 4;

FIG. 6 is a front view illustration of another of the steps required in the method according to the embodiment of the invention shown in FIG. 4; and

FIG. 7 is a perspective view illustration of a strike assembly according to an embodiment of the invention.

### DETAILED DESCRIPTION OF THE INVENTION

Preferred embodiments of the invention provide for apparatus and methods that allow for easy to install and aesthetically pleasing door hardware—for example a latch assembly in a door edge or a strike assembly in a door jamb.

### Receiving Member

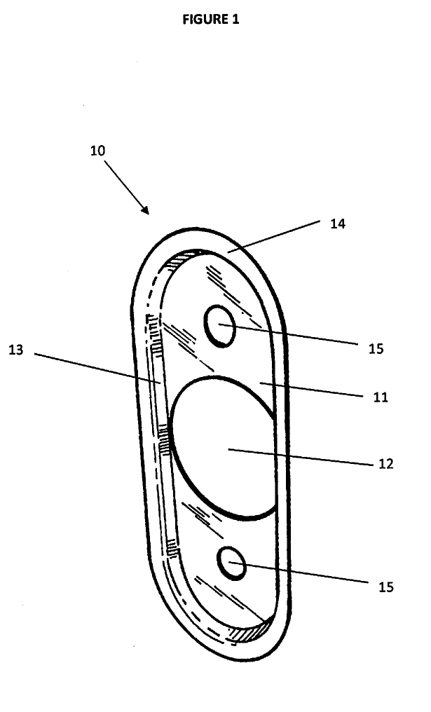

FIG. 1 shows a perspective view illustration of a receiving member 10 for a latch or strike assembly according to a preferred embodiment of the invention. The receiving member 10 comprises plate member 11 in the form of a substantially planar body portion, with a hole 12 in the middle thereof with substantially the same diameter as the width of the plate member 11. In other embodiments the diameter of the hole may be less than the width of the plate member. The hole 12 is of sufficient size to allow the latch or bolt of a door latch mechanism to pass therethrough. The hole may be only slightly bigger than the width of the latch.

The plate member 11 has semi-circular ends distal from the hole 12, and a straight side on either side of the hole 12 tangent to the semi-circular ends. Around the perimeter of the plate member 11 is wall 13 extending away from and substantially perpendicular to the plate member 11. The wall therefore comprises the same outer shape as the plate member 11. At the top of the wall 13 is a flange 14, which extends outwardly around the perimeter of the wall on the opposite side of the wall to the plate member, i.e. distal from the plate member 11. The flange 14 is substantially parallel to the plate member 11. Concentric with each semi-circular end of the plate member 11 are fastener holes 15.

In this embodiment the length of plate member is between two and three times greater than the width.

A purpose of the receiving member 10 is to fit within an appropriately sized recess formed in the edge of a door or in a door jamb, and to receive other parts which may be used in the edge of a door or in a door jamb, such as a latch assembly or a strike assembly. The receiving member may be alternatively known as a strikeplate, faceplate or forend. An appropriately sized recess would therefore be a recess with sides and ends corresponding to the shape and size of the sides and ends of the wall 13 of the receiving member 10, and the recess would therefore be at least as deep as the height of the wall 13, such that when installed the flange 14 extends around and over the edge of the recess. This provides the advantage that the edge of the recess is concealed, which provides an aesthetically pleasing appearance, especially when the edge of the recess is untidy, for example resulting from chiselling or cutting techniques. Further advantages of the shape and size of the receiving member 10 will become apparent in the description below.

In preferred embodiments the receiving member is formed of a thin yet resilient material such as steel sheet having a thickness of less than 1 mm, such as 0.25 mm. A thin flange extended around the edge of the recess minimises the possibility of the door contacting the receiving member when opening/closing.

### Latch Assembly

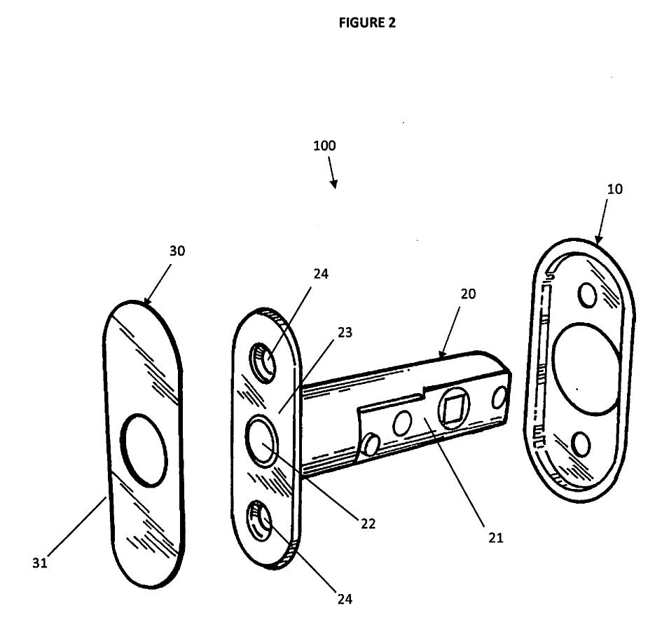

FIG. 2 shows an exploded perspective view illustration of a latch assembly 100 according to a preferred embodiment of the invention. The latch assembly 100 comprises a receiving member 10 as has been previously described with reference to FIG. 1, a latch 20, and a cover 30. The latch 20 comprises a latch body 21 which houses the mechanism for allowing and controlling movement of a latch bolt 22 relative to the latch body 21. The latch 20 comprises a latch head 23 at the end of the latch 20 from which the latch bolt 22 extends.

The latch head 23 has a size and shape such that it is configured to fit within the space between the plate member 11 and the wall 13 of the receiving member 10. The receiving member 10 can therefore receive and locate the latch 20, by receiving the latch body 21 through the hole 12, and can receive the latch head 23 within the space formed between the plate member 11 and the wall 13. The latch head 23 has a thickness sized such that when latch 20 and receiving member 10 are assembled and the surface of the latch head 23 on the same side as the latch body 21 is in abutment with the plate member 11, the top surface of the flange 14 is flush with or proud of the latch head 23. In this embodiment the top surface of the flange 14 is proud of the latch head 23 to allow for a cover 30 to be placed over the surface of the latch head 23 opposite the latch body 21. The cover 30 is a substantially planar member sized and shaped to fit inside the walls of receiving member 10 and having a central hole 31 that allows the latch bolt 22 to extend therethrough.

The latch head 23 comprises two fastener holes 24 which are positioned to correspond to fastener holes 15 in the receiving member 10. Fasteners such as screws can therefore be used to mount the latch 20 and receiving member 10 together in the edge of a door, via fastener holes 24 and 15. The cover 30 can then be adhered to the outer surface of the latch head 23 to conceal the screws, which may improve the aesthetic appearance of the latch assembly 100.

In this preferred embodiment shown in the Figures the latch 20 is a magnetic style latch. The latch bolt 22 is biased, for example spring-loaded, towards a retracted position in which the latch bolt 22 is substantially flush with the surface of the latch head 23. There is a magnet in the latch bolt 22 configured such that the latch bolt 22 can be attracted to a magnet configured appropriately in a strike mounted in a door jamb, for example. This way, when the door in which the latch 20 is installed is open, the bias mechanism urges the latch bolt 22 to the retracted position, allowing the door to be closed. When the door is closed such that the latch 20 is adjacent a strike assembly, a latch bolt 22 can then be attracted to a magnet in the strike assembly, pulling the latch bolt 22 into the extended position such that it is received by the strike assembly, preventing the door from opening. The latch body 21 comprises any mechanism that allows the latch bolt 22 to be retracted when the door is to be opened—for example the latch body 21 may comprise a mechanism connected to a door handle adapted to pull back the latch bolt 22 when the door handle is turned, as is known in the art.

### Template Member

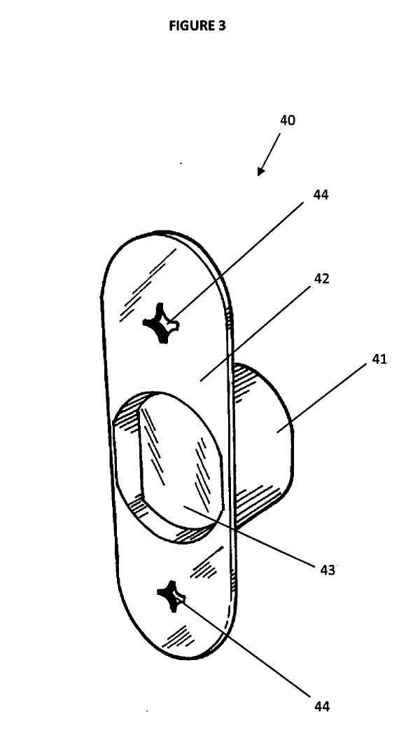

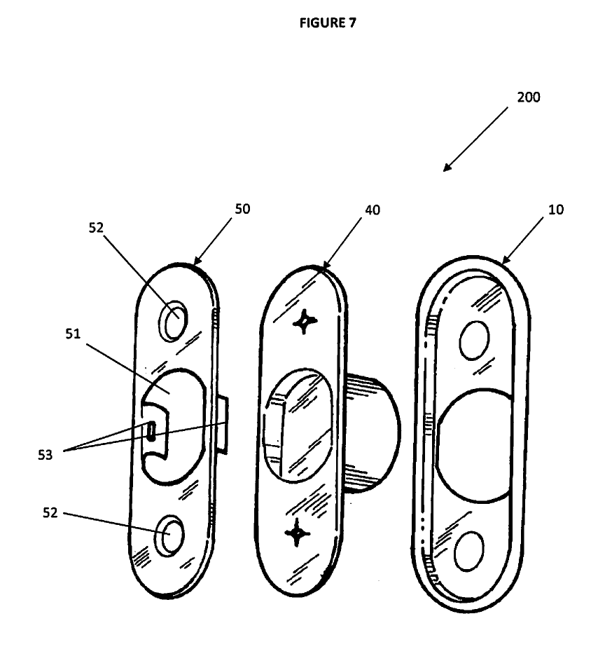

FIG. 3 shows a perspective view illustration of a template member 40. Template member 40 is used to mount a strike or latch assembly, such as has been described with reference to FIG. 1, to a door or door jamb. Template member 40 comprises a body having a central portion 41 and a planar portion 42. Planar portion 42 extends perpendicularly from the central portion 41 on two opposing sides thereof. In the embodiment shown the planar portion 42 extends from one end of the central portion 41 such that the corresponding end of the template member is substantially flat. The shape of planar portion 42 is therefore formed by two straight sides and two semi-circular ends, the straight sides each being tangent to both semi-circular ends. There is a central hole 43 formed through the planar portion 42 and into the central portion 41. On each opposing side of the planar portion 42 is a guide hole 44. Each guide hole 44 has a centre substantially aligned with the centre of the semi-circular end. In this embodiment the guide holes 44 are advantageously formed in a plus shape with an enlarged centre. The enlarged centre provides a guide for drilling a small pilot hole, for example of around 3 mm diameter. A larger screw is then able to be installed through the template member 40 (as will be described with reference to FIG. 7) while the template member 40 is still in place, because the corners of the plus shape are able to freely bend away as the larger screw passes through the template member 40, without causing structural damage to the template member, as in preferred embodiments the template member is formed from a soft plastics material.

The size and shape of the planar portion 42 of the template member 40 corresponds to the size and shape of the area enclosed within wall 13 of the receiving member 10. Similarly, when the template member 40 is positioned within wall 13 of receiving member 10, each guide hole 44 of the template member 40 is aligned with one of the fastener holes 15 of the receiving member 10. Furthermore, the central portion 41 comprises substantially the same diameter as the hole 12 in the receiving member 10. The thickness of the planar portion 42 of the template member 40 is less than the height of the wall 13, the reasons for which will become apparent after reading the explanation of the use of template member 40 below.

### Method of Forming a Recess

The template member 40 assists in installing a latch assembly. It is especially useful in preparing a recess into which the receiving member 10 as previously described can be installed. A method in which template member 40 can be used to do so is now described with reference to installing the latch assembly 100, as described with reference to FIG. 2, into the edge of a door—in this preferred embodiment, a wooden door.

A deep hole can first be drilled in the edge of the door at the desired height of the latch bolt 22. This hole forms the cavity in the door which receives the latch body 21 of the latch 20. The diameter of the hole is greater than the size of the latch body 21 proximate the latch head 23, but preferably only slightly greater so that the latch body 21 can be held in place securely within the hole. Similarly the diameter of the hole corresponds to the width between the two side walls of the receiving member 10. ‘Deep’ in the context of this hole means that it is sufficiently deep so as to be able to fully receive latch body 21.

The central portion 41 of the template member 40 can then be inserted into the hole drilled into the edge of the door, far enough into the hole such that the planar portion 42 abuts the surface of the edge of the door around the hole. In preferred embodiments the template member 40 is oriented vertically such that the two pilot holes 44 and the central hole 43 (and therefore the hole drilled in the edge of the door) are all located on a substantially vertical line.

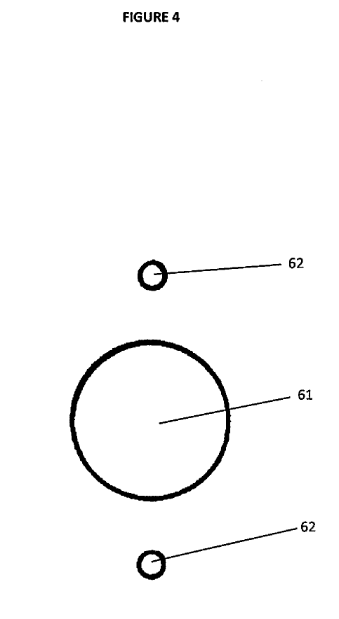

The guide holes 44 in the template member 40 can then be used as guides to drill (or mark for drilling) two further holes in the edge of the door above and below the deep hole already drilled. FIG. 4 shows a front view illustration of the result of the method steps already described, with the template member 40 removed from the edge of the door. FIG. 4 shows a central hole 61 that has been drilled deep into the door to house the latch body 21, and pilot holes 62 that have been drilled above and below the central hole 61 using the guide holes 44 as guides to ensure their correct locations.

With the template member 40 removed from the door edge, the pilot holes 62 can be widened to a diameter of substantially the same diameter as the central hole 61, however in this embodiment they are drilled only as deep or slightly deeper than is required to eventually receive the receiving member 10 such that the flange 14 of the receiving member 10 fits against the surface of the door edge. Therefore, the pilot holes 62 must be deepened to a depth at least as deep as the wall 13 of the receiving member 10 when the receiving member 10 is, eventually, received in the door. One way of widening and deepening the pilot holes 62 is using a spade drill bit. The depth to which the pilot holes 62 are widened can be greater than the height of the wall, because the flange 14 will prevent the receiving member 10 from being installed too deep into the door, as the flange 14 is wider than the diameter of the holes being drilled—this positions the latch 20 at the correct depth in the door, even if the recess is formed slightly too deep.

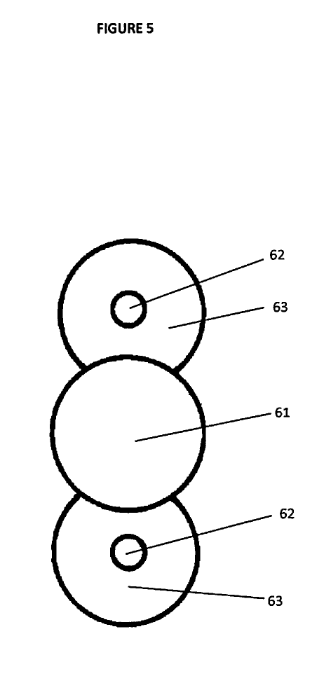

FIG. 5 shows a front view illustration of the recess after the above steps have been performed. Pilot holes 62 are still visible on either side of central hole 61, and widened holes 63 are also now visible. The pilot holes 62 are, in this embodiment, still visible because they have been drilled deeper than the intended depth of the widened holes 63. In this embodiment the pilot holes 62 will eventually be used to receive screws, so they may be drilled to a depth at least as deep as the screws will penetrate into the door when installed.

Finally, as there is still wood that has not been removed from the space between the widened holes 63 and the central hole 61, the next step in the method of forming a recess is to remove this remaining material, for example by using a chisel. In this preferred embodiment a downward chiselling action is used, which, depending on the nature of the door, may advantageously mean that the only chiselling required is chiselling “with” the grain of the wood—i.e. chiselling parallel to the direction of the grain of the wood, which makes it much easier to form straight sides that have a neat appearance by chiselling. Other cutting techniques may also be used.

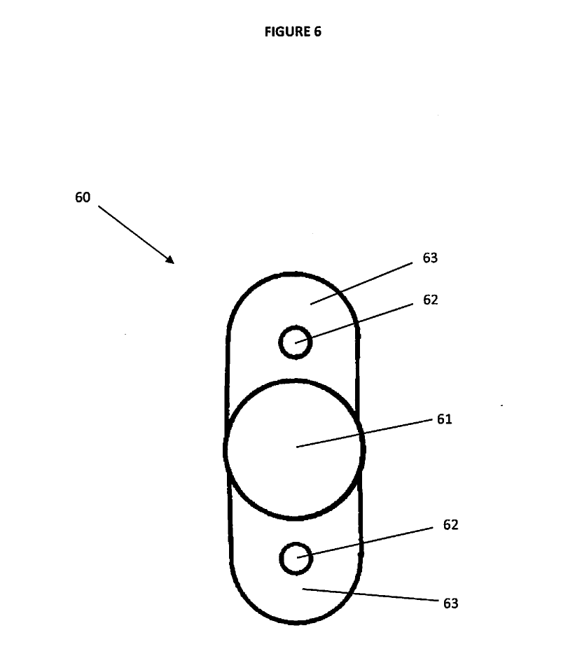

FIG. 6 shows a front view illustration of the end result of the above described method steps—recess 60. Central hole 61, which receives the latch body 21 and also corresponds to the hole 12 in the receiving member 10, is visible in the centre of the recess 60, and is substantially the same width as the sides of the recess. The pilot holes 62 are also visible as they may be drilled deeper than the widened holes 63. The ends of the recess 60, which are semi-circular are therefore formed by the widened holes 63.

Using the template member 40, the recess 60 has been formed using only basic tools, to a size in which the receiving member 10 can be installed. The rest of the latch assembly can then be installed in the arrangement described with reference to FIG. 2. The latch 20 can be inserted through the hole 12 in the receiving member 10 and into the central hole 61 in the door edge, and pushed inwards until the latch head 23 abuts the plate member 11 of the receiving member 10. Screws or other fasteners can then be used, one each through fastener holes 24 and 15 into the pilot hole 62, to secure the latch 20 and receiving member 10 together into the door.

The cover 30 is then adhered to the exposed surface of the latch head 23 to cover the screw heads to improve the aesthetic appearance of the installed latch assembly 100.

### Strike Assembly

The recess 60 has been described above with reference to installing a latch assembly in the edge of a door, however the recess 60 can also be formed in a door jamb, in order to provide a recess in which a strike assembly could be installed.

FIG. 7 shows an exploded perspective view of a strike assembly 200, comprising receiving member 10, template member 40 and a plate 50. The strike assembly 200 can be installed in a recess of a door jamb, for example a recess similar to recess 60 as described above except formed in a door jamb rather than a door edge.

As the size and shape of the planar portion 42 and central portion 41 of the template member 40 correspond to the internal size and shape of the receiving member 10, as has previously been described, the template member can therefore be received by the receiving member, with the guide holes 44 and fastener holes 15 being aligned.

As has been previously described, the thickness of the planar portion 42 of the template member is less than the height of the wall 13 of the receiving member. This allows for the plate 50 to be placed over the template member 40 when assembled with the receiving member 10, without the plate 50 standing proud of the flange 14 of the receiving member 10.

In preferred embodiments, when the template member 40 forms part of the strike assembly 200, a magnet is secured within the central portion 41 of the template member, for example inside hole 43 in the side of central portion 41 with an opening co-planar with planar portions 42. The magnet is configured such that its position and orientation attracts a magnetic latch bolt, for example latch bolt 22, to provide the function and associated advantages described above with reference to the magnet in the latch bolt 22. The magnet in the template member 40 may have a protective covering over the surface towards which the latch bolt 22 extends, allowing the end of the latch bolt to contact that protective covering without damaging the magnet. The protective covering in preferred embodiments is a foam or foam like material. The depth of the surface of the magnet or protective covering within hole 43 may be varied by some means, for example by placing a spacer member into hole 43 under the magnet or covering.

The plate 50 is in this embodiment a planar member of the same shape and size as the planar portion 42 of the template member 40, however is preferably formed from steel sheet having a thickness of 1 mm or 1.2 mm or similar. The plate 50, which when aligned with the planar portion 42, has a central hole 51 aligned with hole 43 of the template member 40, and two fastener holes 52 aligned with the guide holes 44 of the template member 40. The central hole 51 has straight sides which, when the plate 50 is assembled with the template member 40, are parallel with the straight sides of the template member 40. On the inside of the straight sides of the hole 51 of the plate 50 are two tabs 53 which extend perpendicular to the planar body of the plate 50, in a direction such that they extend into the hole 43 of the template member 40 when the plate 50 and template member 40 are assembled. These tabs 53 aid in locating the plate 50 during installation, and can be bent as required to reduce any freedom of the latch bolt 22 to move or rattle (i.e. reduce or eliminate play) within the strike 200.

As was described with reference to FIG. 3, the planar portion 42 has a thickness sized such that, when the template member 40 and receiving member 10 are assembled and the planar portion 42 is in abutment with the plate member 11, the top surface of the flange 14 is flush with or proud of the planar portion 42. In this embodiment the top surface of the flange 14 is proud of the planar portion 42 to allow for the plate 50 to be placed over the surface of the planar portion 42, such that the flange 14 remains proud of the exposed surface of the plate 50, at least to allow for a cover 30 to be placed over plate 50.

After the strike assembly 200 has been installed in a door jamb and secured with screws, a cover, which may be a cover 30 as was described with reference to FIG. 2, can then be adhered to the outer surface of the plate 50 to conceal the screws, which may improve the aesthetic appearance of the strike assembly 200.

### Door Closure Kit and Method of Installing Same

As has been described with reference to the figures, in preferred embodiments of the invention there are various parts that can together form a door closure kit for a door closure system—that is, a kit of parts able to be used to install a door closure system in a door and jamb.

Such a kit may comprise:
a latch assembly 100 (which itself may comprise a receiving member 10, a latch 20 and a cover 30);
a strike assembly 200 (which itself may comprise a receiving member 10, a plate 50 and a cover 30);
a template member 40, which in some embodiments forms part of the strike assembly 200;
any other components which may be required for a door closure system yet are known in the art—for example fasteners, door handles etc.

A door closure system could be installed using the above kit with a method including the steps of:
drilling a hole in the edge of the door at the desired height of the latch bolt 22;
using the template member 40 to drill pilot holes 62 on either side of the already drilled central hole 61 in the door edge;
forming the recess 60 in the door edge;
inserting the receiving member 10 and latch 20 into the recess 60 in the door edge, securing with screws and adhering the cover 30 to the exposed surface of the latch head 23;
drilling a hole in the door jamb at the desired height of the hole 51 to receive the latch bolt 22;
using template member 40 to drill pilot holes 62 on either side of the already drilled central hole 61 in the door jamb;
forming the recess 60 in the door jamb;
inserting the receiving member 10, template member 40 and plate 50 into the recess 60 in the door jamb, securing with screws and adhering the cover 30 to the exposed surface of the plate 50.

Other steps may be included as may be apparent to those skilled in the art and would be required to install a door closure system, either before, after or in between performing the above steps—one non-limiting example of a step not mentioned above is installing door handles.

### Alternative Embodiments

Many features of the latch assembly and strike assembly described above with reference to the Figures are features specific to only some of the possible embodiments of the invention.

The latch may be any suitable type of latch. For example, rather than being a magnetic style latch it may be of the more common variety in which the latch bolt is springloaded into the extended position and it has a contoured or angled surface to allow it to be pushed back into the latch body as it passes the door jamb while the door is closed. In such an embodiment the plate forming part of the strike assembly may have a contoured lip to assist in smoothly pushing the latch bolt back into the latch body. In such an embodiment the flange of the receiving member may not extend all the way around the wall of the receiving member, in order to leave space for the lip to extend out from the side. In some embodiments the lip may be integrally formed with the flange.

The receiving member and associated methods of installing the receiving member as part of a latch or strike assembly may not be limited to latches in swinging doors, but rather may be used with other types of tubular latch bolts, for example privacy bolts, dead bolts, sliding door latches.

Not all the various parts of embodiments of the invention described above need to be used in all installations. For example, a receiving member may be used as part of a latch assembly, but the strike or strike assembly may be of a conventional type, or vice versa. Furthermore, the method of forming a recess could be used to form a recess for a conventional latch or strike with straight sides and semi-circular ends similar to the latch/strike described above.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A method of creating a recess in a door or a jamb, the method comprising:
a) drilling a first hole into the door or the jamb, as the case may be;
b) drilling a second hole having a centre offset from the centre of the first hole;
c) widening the second hole to substantially the same diameter as the first hole, to at least a portion of the depth of the first hole;
d) removing material from the door or jamb, as the case may be, to form a recess comprising two substantially straight sides, each straight side substantially tangent to each of the previously drilled holes.

2. The method as claimed in claim 1, wherein the method comprises, before step d),
drilling a third hole proximate one of the previously drilled holes, the third hole substantially positioned on the line intersecting the centres of both the first and second holes; and
widening the third hole to substantially the same diameter as the first hole, to at least a portion of the depth of the first hole.

3. The method as claimed in claim 2, wherein the method comprises, after step a), inserting the central portion of a template member according to any one of claims 1-8 into the first hole, and drilling the second hole and the third hole each at the location of a guide hole of the template member.

4. The method as claimed in claim 3, wherein the method comprises marking the position of the second and/or third holes through first and/or second guide holes in the template member prior to drilling the second and/or third holes.

5. The method as claimed in claim 1, wherein the recess is configured to receive a latch assembly.

6. The method as claimed in claim 1, wherein the recess is configured to receive a strike assembly.

7. A method of installing a receiving member for a latch assembly or strike assembly comprising the steps of:
creating a recess in a door or a jamb by the steps of:
a) drilling a first hole into the door or the jamb, as the case may be;
b) drilling a second hole having a centre offset from the centre of the first hole;
c) widening the second hole to substantially the same diameter as the first hole, to at least a portion of the depth of the first hole;
d) removing material from the door or jamb, as the case may be, to form a recess comprising two substantially straight sides, each straight side substantially tangent to each of the previously drilled holes;
the method further comprising the step of inserting the receiving member into the recess.

8. A door hardware including a receiving member, the receiving member comprising:
a plate member comprising two semi-circular sides connected by two straight sides, the plate member further comprising two fastener holes, each substantially concentric with the center of one of the semi-circular sides, and further having a hole therein, the hole being configured to allow a latch to pass therethrough;
a wall around the perimeter of the plate member, the wall extending away from and substantially perpendicular to the plate member; and
a flange extending outwardly from the perimeter of the wall distal from the plate member, the flange extending around the entire perimeter of the wall;
wherein the receiving member is configured to be mounted in a recess in a door jamb or door edge such that the flange abuts a surface of the door jamb or door edge, as the case may be, and substantially conceals the edge of the recess.

9. The receiving member as claimed in claim 8, wherein the plate member comprises a shape having a length and a width, the length being between two and three times greater than the width.

10. The receiving member as claimed in claim 8, wherein the hole configured to allow a latch to pass therethrough is located substantially in the middle of the length of the plate member.

11. The receiving member as claimed in claim 8, wherein the hole is circular and has a diameter substantially equal to the width of the plate member.

12. A receiving member as claimed in claim 8, wherein the receiving member is configured to receive one or more further components of a latch assembly or a strike assembly, within the space between the wall and the plate member.
